(19) United States
(12) Patent Application Publication
(10) Pub. No.: US 2016/0013605 A1
(43) Pub. Date: Jan. 14, 2016

(54) Pulse Compressor

(71) Applicant: Brookhaven Science Associates, LLC, Upton, NY (US)

(72) Inventor: Mikhail Polyanskiy, Port Jefferson, NY (US)

(73) Assignee: Brookhaven Science Associates, LLC, Upton, NY (US)

(21) Appl. No.: 14/793,052

(22) Filed: Jul. 7, 2015

Related U.S. Application Data
(60) Provisional application No. 62/021,725, filed on Jul. 8, 2014.

(51) Int. Cl. H01S 3/00; G02B 27/30; G02B 27/09; G02F 1/35

(52) U.S. Cl. CPC H01S 3/0057; G02F 1/3501; G02B 27/30; G02B 27/0988; G02F 2001/3503

(57) ABSTRACT

Technologies are described for methods and systems effective to compress an input pulse to produce an output pulse. The methods may include receiving, by a pulse compressor, the input pulse. The methods may further include producing, by the pulse compressor, an unchirped portion of the input pulse. The methods may further include producing, by the pulse compressor, a chirped portion of the input pulse. The methods may further include filtering out, by the pulse compressor, the unchirped portion. The methods may further include compressing, by the pulse compressor, the chirped portion to produce the output pulse.

This application claims the benefit of U.S. Provisional Application 62/021,725 filed on Jul. 8, 2014, the entire contents of which are incorporated herein by reference.

### STATEMENT OF GOVERNMENT RIGHTS

The present application was made with government support under contract numbers DE-AC02-98CH10886 and DE-SC0012704 awarded by the U.S. Department of Energy. The United States government has certain rights in the invention.

### FIELD OF THE INVENTION

This disclosure relates generally to a laser pulse compressor.

### BACKGROUND

A pulse may be compressed from a first duration to a second duration that may be less than the first duration. An intensity of the pulse may also increase as a result of the compression of the pulse. Compression of ultra-short pulses may lead to undesirable effects such as self-focusing, limited compressibility, instability in the compressed pulse, etc.

### SUMMARY

In some examples, a pulse compressor is generally described. The pulse compressor may include a transmission medium. The transmission medium may be effective to receive an input pulse, produce an unchirped portion of the input pulse and produce a chirped portion of the input pulse. The pulse compressor may further include a spatial filter in operational relationship with the transmission medium. The spatial filter may be effective to receive the chirped portion and unchirped portion and filter out the unchirped portion. The pulse compressor may further include a collimator in operational relationship with the spatial filter. The collimator may be effective to receive and collimate the chirped portion to produce a collimated pulse. The pulse compressor may further include a compressing device in operational relationship with the transmission medium, the spatial filter, and the collimator. The compressing device may be effective to receive and compress the collimated pulse to produce an output pulse.

In some examples, methods for compressing a pulse are generally described. The methods may include, by a device, receiving an input pulse. The methods may further include producing an unchirped portion of the input pulse. The methods may further include producing a chirped portion of the input pulse. The methods may further still include filtering out the unchirped portion. The methods may include compressing the chirped portion to produce an output pulse.

In some examples, a device is generally described. The device may include a transmission medium being effective to receive an input pulse, produce an unchirped portion of the input pulse, and produce a chirped portion of the input pulse. The device may further include a spatial filter in operational relationship with the transmission medium. The spatial filter may be effective to filter out the unchirped portion of the input pulse, and output the chirped portion of the input pulse.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates a system drawing of a pulse compressor;

FIG. 2 illustrates a system drawing of an implementation of a pulse compressor; and

FIG. 3 illustrates a flow diagram of an example process to implement a pulse compressor;

all arranged according to at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

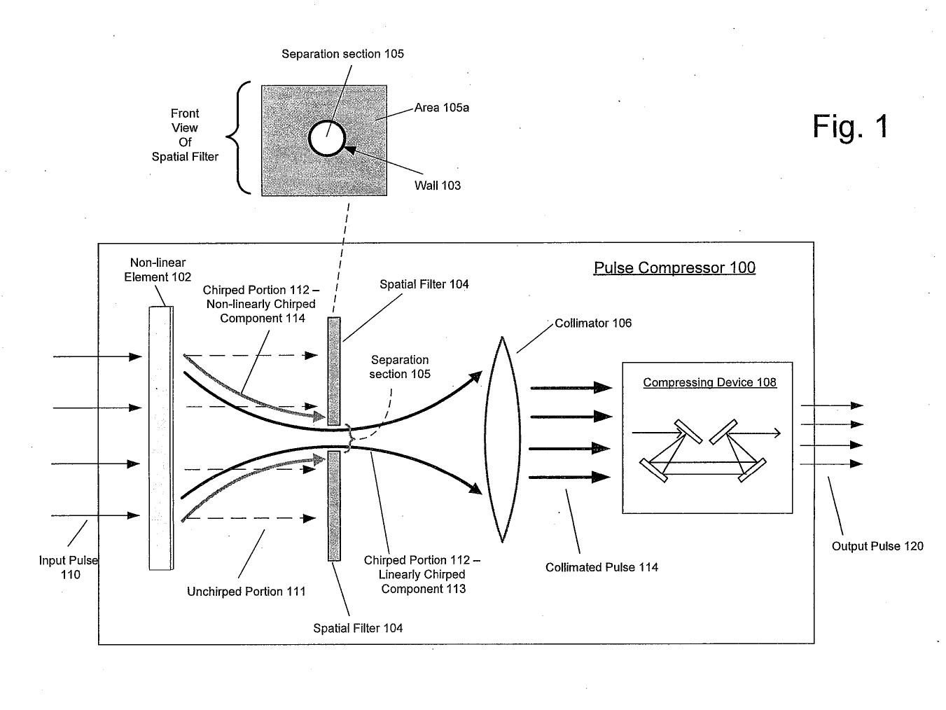

In FIG. 1 a system is drawn illustrating a pulse compressor 100, arranged in accordance with at least some embodiments presented herein. As discussed in more detail below, a pulse compressor 100 may include a transmission medium 102 in operational relationship with a spatial filter 104. An input pulse 110 may propagate, such as for example from a light source, to pulse compressor 100. An example of input pulse 110 may be an ultra-short pulse from a laser that is of a duration of less than approximately 1 nanosecond (ns). Pulse compressor 100 may perform compression on input pulse 110 to produce an output pulse 120. Input pulse 110 may travel through compressor 100 such as propagating through mechanisms of compressor 100 during the compression of input pulse 110.

Pulse compressor 100 may include a transmission medium 102, a spatial filter 104, a collimator 106, and/or a compressing device 108. Transmission medium 102, spatial filter 104, collimator 106, and/or compressing device 108 may be in operational relationship with each other. Transmission medium 102, spatial filter 104, and collimator 106 may be positioned relative to each other based on parameters of input pulse 110 (described below). Spatial filter 104 may be positioned between transmission medium 102 and collimator 106. A distance between transmission medium 102 and spatial filter 104 may be based on parameters of input pulse 110. A distance between spatial filter 104 and collimator 106 may also be based on parameters of input pulse 110.

Transmission medium 102 may be a non-linear dispersive medium such as for example a germanium window. Transmission medium 102 may have a refractive index, wherein the refractive index may include a linear component and a non-linear component. The refractive index may be based on a material composition of transmission medium 102. As input pulse 110 propagates through transmission medium 102, an unchirped portion 111 of input pulse 110 may be produced based on the linear component of the refractive index. Unchirped portion 111 may be a portion of input pulse 110 which propagates at a frequency that does not vary in time.

Similarly, as input pulse 110 propagates through transmission medium 102, a chirped portion 112 of input pulse 110 may be produced based on the non-linear component of the refractive index. Chirped portion 112 may be a result of self-phase modulation and/or self-chirping of input pulse 110. Chirped portion 112 may be a portion of input pulse 110 which propagates at a frequency that varies in time. In some examples, chirped portion 112 may include a linearly chirped component 113 and may include a non-linearly chirped component 114. Linearly chirped component 113 may be a portion of chirped portion 112 which propagates at a frequency that varies with time linearly. Non-linearly chirped component 114 may be a portion of chirped portion 112 which propagates at a frequency that varies with time non-linearly.

Unchirped portion 111 and chirped portion 112 of input pulse 110 may propagate to spatial filter 104. Spatial filter 104 may be effective to filter out unchirped portion 111 and may be effective to filter out non-linearly chirped component 114. Spatial filter 104 may be effective to output the chirped portion 112 of the input pulse 110. Spatial filter 104 may be a sheet of metal and may include a separation section 105. In some examples, separation section 105 may be made of a transparent material. In some examples, separation section 105 may be an aperture formed by a wall 103. As a result of the filtering by spatial filter 104, chirped portion 112 may propagate through separation section 105. In an example, focusing on a front view of spatial filter 104, spatial filter 104 may include an area 105a which may be effective to block, absorb, or reflect unchirped portion 111 and non-linearly chirped component 114. Filtering of unchirped portion 111 and non-linearly chirped component 114 may be based on a size of separation section 105. The size of separation section 105 may be based on parameters of input pulse 110, such as intensity, wavelength, frequency, energy, time duration, etc.

Collimator 106 may include one or more lenses, such as a curved lens. In an example, collimator 106 may include a lens with a focal distance equal to a distance between spatial filter 104 and collimator 106. As a result of propagation through collimator 106, chirped portion 112 may be collimated to produce collimated pulse 114. Collimated pulse 114 may include rays of chirped portion 112 where the rays propagate in parallel. Collimated pulse 114 may propagate to compressing device 108.

Compressing device 108 may be a grating compressor or a negative-dispersion window. Compressing device 108 may include more than one grating effective to diffract collimated pulse 114. Compressing device 108 may be effective to compress collimated pulse 114 to produce output pulse 120. Output pulse 120 may be a compressed variation of input pulse 110. A time duration of output pulse 120 may be less than a time duration of input pulse 110. A power of output pulse 120 may be greater than a power of input pulse 110.

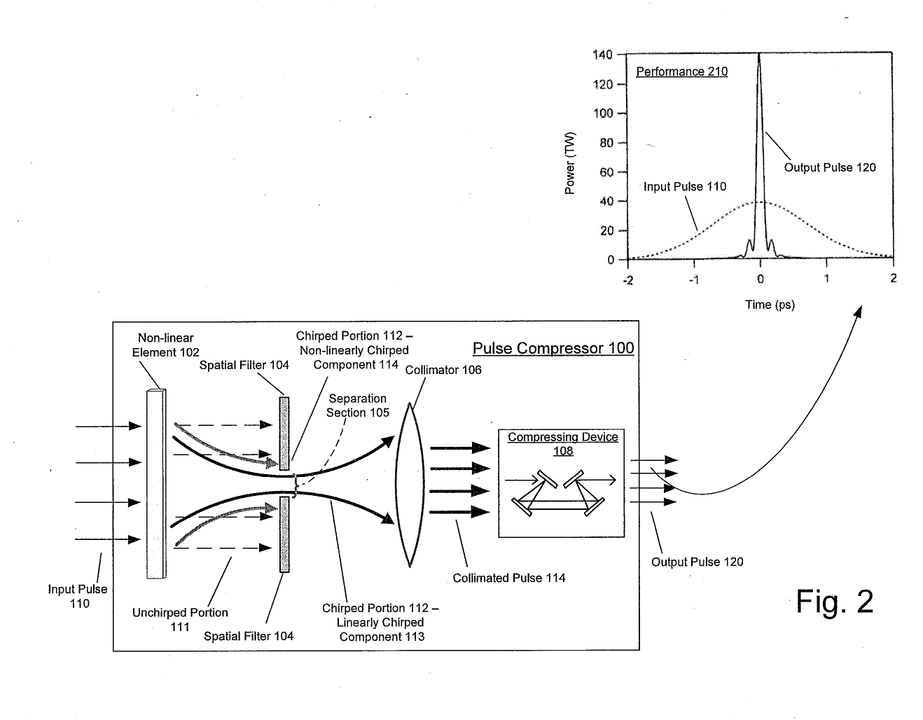

In FIG. 2 a system is drawn illustrating an example relating to an implementation of pulse compressor 100, arranged in accordance with at least some embodiments presented herein. FIG. 2 is substantially similar to system 100 of FIG. 1, with additional details. Those components in FIG. 2 that are labeled identically to components. of FIG. 1 will not be described again for the purposes of clarity.

In an example, input pulse 110 may be a pulse from a carbon dioxide laser of a wavelength of 10-microns, time duration of 1.7 picoseconds, and energy of 70 Joules. Non-linear element 102 may be a germanium window of a thickness of two millimeters. A distance between non-linear element 102 and spatial filter 104 may be six meters. As a result of compression performed by pulse compressor 100, output pulse 120 may be a pulse of time duration of 100 femtoseconds, and energy of 18 Joules. As shown by performance 210, output pulse 120 includes a significantly higher power than input pulse 110. Time duration of output pulse 120 is also significantly lower than the time duration of input pulse 110.

A system in accordance with the present disclosure may provide a method to compress ultra-short pulses in a more efficient manner. Laser beams with Gaussian intensity distribution can be compressed even if the beam undergoes self-focusing, where a refractive index of a transmission medium changes. Contributions from low intensity portions of the laser beam need not affect the ability of the compressor to compress the beam. Similarly, variations in intensity of input pulses need not affect the compressibility.

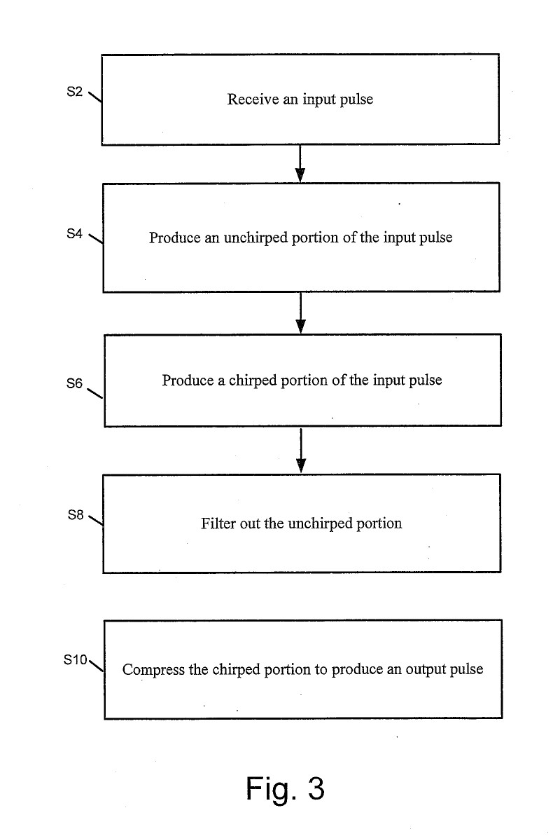

FIG. 3 illustrates a flow diagram of an example process to implement a pulse compressor, arranged in accordance with at least some embodiments presented herein. The process in FIG. 3 could be implemented using, for example, system 100 discussed above. An example process may include one or more operations, actions, or functions as illustrated by one or more of blocks S2, S4, S6, S8, and/or S10. Although illustrated as discrete blocks, various blocks may be divided into additional blocks, combined into fewer blocks, or eliminated, depending on the desired implementation.

Processing may begin at block S2, “Receive an input pulse”. At block S2, a pulse compressor may receive an input pulse. In some examples, the input pulse may be an ultra-short pulse of an order less than 1 nanosecond.

Processing may continue from block S2 to block S4, “Produce an unchirped portion of the input pulse”. At block S4, the pulse compressor may produce an unchirped portion of the input pulse. Production of the unchirped portion of the input pulse may include propagating the input pulse through a non-linear transmission medium. In some examples, the non-linear transmission medium may be a germanium window.

Processing may continue from block S4 to block S6, “Produce a chirped portion of the input pulse”. At block S6, the pulse compressor may produce a chirped portion of the input pulse. Production of the chirped portion of the input pulse may include propagating the input pulse through the non-linear element. The chirped portion may include a linearly chirped component and a non-linearly chirped component.

Processing may continue from block S6 to block S8, “Filter out the unchirped portion”. At block S8, the pulse compressor may filter out the unchirped portion of the input pulse. The pulse compressor may perform the filtering based on a size of an aperture of a spatial filter. The pulse compressor may further filter out the non-linearly chirped component of the chirped portion of the input pulse.

Processing may continue from block S8 to block S10, “Compress the chirped portion to produce an output pulse”. At block S10, the pulse compressor may compress the chirped portion of the input pulse to produce an output pulse. The compressor may be one of a grating compressor or a negative-dispersion window. In some examples, prior to compressing the chirped portion, the collimator may collimate the chirped portion.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A pulse compressor comprising:
a transmission medium effective to:
receive an input pulse;
produce an unchirped portion of the input pulse; and
produce a chirped portion of the input pulse;
a spatial filter in operational relationship with the transmission medium, the spatial filter being effective to receive the chirped portion and unchirped portion and filter out the unchirped portion;
a collimator in operational relationship with the spatial filter, the collimator being effective to receive and collimate the chirped portion to produce a collimated pulse; and
a compressing device in operational relationship with the transmission medium, the spatial filter, and the collimator, the compressing device being effective to receive and compress the collimated pulse to produce an output pulse.

2. The pulse compressor of claim 1, wherein the spatial filter is positioned between the transmission medium and the collimator, wherein a first distance between the transmission medium and the spatial filter is based on parameters of the input pulse, and a second distance between the spatial filter and the collimator is based on the parameters of the input pulse.

3. The pulse compressor of claim 1, wherein the input pulse is an ultra-short pulse of less than approximately 1 nanosecond.

4. The pulse compressor of claim 1, wherein the transmission medium includes a non-linear medium.

5. The pulse compressor of claim 1, wherein the chirped portion includes a linearly chirped component and a non-linearly chirped component, the spatial filter is further effective to filter out the non-linearly chirped component, and the collimator is further effective to receive and collimate the linearly chirped component.

6. The pulse compressor of claim 1, wherein the spatial filter includes an aperture defined by a wall.

7. The pulse compressor of claim 6, wherein the aperture is transparent.

8. The pulse compressor of claim 1, wherein the transmission medium is a germanium window.

9. The pulse compressor of claim 1, wherein the compressor is one of a grating compressor or a negative-dispersion window.

10. A method for compressing a pulse, the method comprising, by a device:
receiving an input pulse;
producing an unchirped portion of the input pulse;
producing a chirped portion of the input pulse;
filtering out the unchirped portion;
compressing the chirped portion to produce an output pulse.

11. The method of claim 10, wherein, prior to compressing the chirped portion, the method further comprises collimating the chirped portion to produce a collimated pulse.

12. The method of claim 10, wherein the input pulse is an ultra-short pulse of less than approximately 1 nanosecond.

13. The method of claim 10, wherein producing the unchirped portion and producing the chirped portion includes using a non-linear transmission medium.

14. The method of claim 13, wherein the chirped portion includes a linearly chirped component and a non-linearly chirped component, and the method further comprises filtering out the non-linearly chirped component and further comprises compressing the linearly chirped component.

15. The method of claim 10, wherein filtering out the unchirped portion includes using a spatial filter.

16. A device comprising:
a transmission medium being effective to:
receive an input pulse;
produce an unchirped portion of the input pulse; and
produce a chirped portion of the input pulse; and
a spatial filter in operational relationship with the transmission medium, the spatial filter being effective to:
filter out the unchirped portion; and
output the chirped portion of the input pulse.

17. The device of claim 16, wherein a distance between the transmission medium and the spatial filter is based on parameters of the input pulse.

18. The device of claim 16, wherein the input pulse is an ultra-short pulse of less than approximately 1 nanosecond.

19. The device of claim 16, wherein the transmission medium includes a germanium window.

20. The device of claim 16, wherein the chirped portion includes a linearly chirped component and a non-linearly chirped component, and the spatial filter is further effective to filter out the non-linearly chirped component and further effective to output the linearly chirped component.
